(19) United States
(12) Patent Application Publication
(10) Pub. No.: US 2016/0267049 A1
(43) Pub. Date: Sep. 15, 2016

(54) DATA STORAGE DEVICE AND DATA TRANSMISSION SYSTEM WITH DATA STORAGE DEVICE

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: Da LIAO, Shenzhen (CN); Xin XIONG, Shenzhen (CN); Zhen TAN, Shenzhen (CN)

(21) Appl. No.: 14/725,965

(22) Filed: May 29, 2015

(30) Foreign Application Priority Data
Mar. 10, 2015 (CN) 201510103077.6

(51) Int. Cl. G06F 13/42; G06F 12/02; G06F 13/40; G06F 12/08

(52) U.S. Cl. CPC G06F 13/4291; G06F 12/0811; G06F 12/0875; G06F 12/0246; G06F 13/4022; G06F 2212/283; G06F 2212/452; G06F 2212/7208

(57) ABSTRACT

A data storage device includes a FPGA chip, a plurality of high speed transmission interfaces coupled to the FPGA chip, a second storage unit coupled to the FPGA chip, and a third storage unit coupled to the FPGA chip. The FPGA chip controls the plurality of first storage units to be used as caches of the data storage device. The second storage unit stores a start configuration for quick start-up of the data storage device. The FPGA chip controls the third storage unit to store data of the data storage device.

### FIELD

The subject matter herein generally relates to a data storage device and a data transmission system with the data storage device.

### BACKGROUND

A great in amount of data is pouring into our lives, from anywhere, anytime, and any device. Data transmission and storage has become important as well.

### BRIEF DESCRIPTION OF THE DRAWINGS

Implementations of the present technology will now be described, by way of example only, with reference to the attached figures.

FIG. 1 is a diagrammatic view of an exemplary embodiment of a data storage device.

FIG. 2 is a diagrammatic view of a data transmission system with the data storage device of FIG. 1.

FIG. 3 is a diagrammatic view of a clock module of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

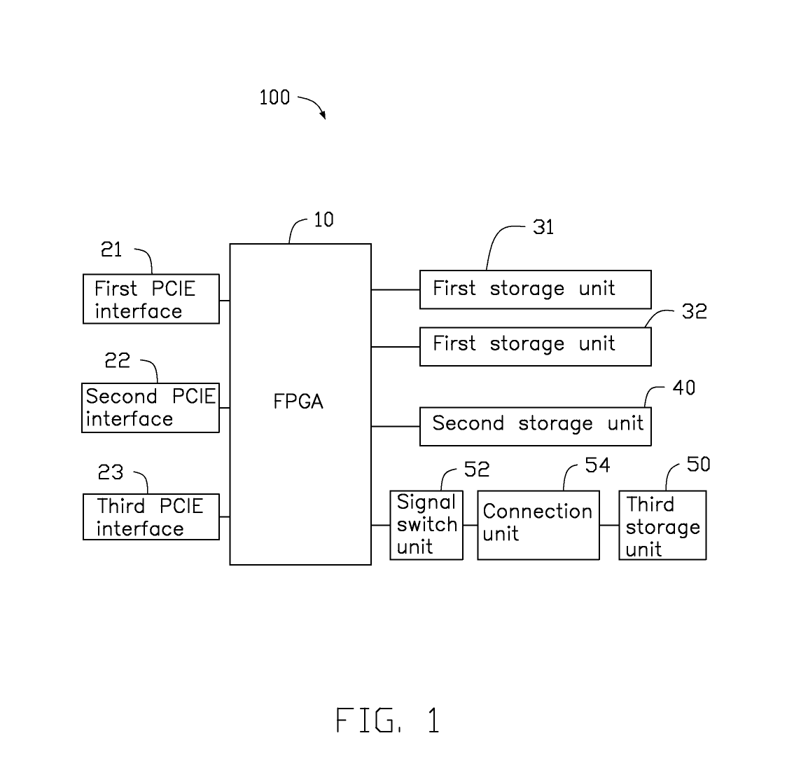

FIG. 1 illustrates an embodiment of a data storage device 100 includes a field-programmable gate array (FPGA) chip 10, a first peripheral component interconnect express (PCIE) interface 21, a second PCIE interface 22, a third PCIE interface 23, two first storage units 31, 32, a second storage unit 40, a third storage unit 50, a signal switch unit 52, and a connection unit 54.

The three PCIE interfaces 21, 22, 23 are coupled to the FPGA chip 10 through PCIE buses. The two first storage units 31, 32 are coupled to the FPGA chip 10. The FPGA chip 10 controls the two first storage units 31, 32 to be used as caches of the data storage device 100. The two first storage units 31, 32 cache data. The second storage unit 40 is coupled to the FPGA chip 10 and stores a start configuration for quick start-up of the data storage device 100. The third storage unit 50 is coupled to the FPGA chip 10 through the connection unit 54 and the signal switch unit 52. The FPGA chip 10 controls the third storage unit 50 to store data of the data storage device 100.

In the illustrated embodiment, the two first storage units 31, 32 are double data rate SDRAM3 (DDR3), the second storage unit 40 is a flash memory, and the third storage unit 50 is four serial advanced technology attachment (SATA) hard disks. The signal switch unit 52 is coupled to the FPGA chip 10 through the PCIE bus. The signal switch unit 52 switches between PCIE signals and SATA signals. In the illustrated embodiment, the connection unit 54 is a serial attached small computer system interface (SAS) connection unit. The connection unit 54 supports four SATA hard disks. In other embodiments, the signal switch unit 52 and the connection unit 54 can be omitted, and the third storage unit 50 is directly coupled to the FPGA chip 10.

When the data storage device 100 performs large data transmission and storage, the data storage device 100 starts-up quick through the second storage unit 40, the data storage device 100 performs high speed data transmission and reception through the three PCIE interfaces 21, 22, 23, the data storage device 100 caches the data through the two first storage units 31, 32, and the data storage device 100 stores the data through the third storage unit 50.

In other embodiments the three PCIE interfaces 21, 22, 23 can be other suitable interfaces, such as, other high speed transmission interfaces.

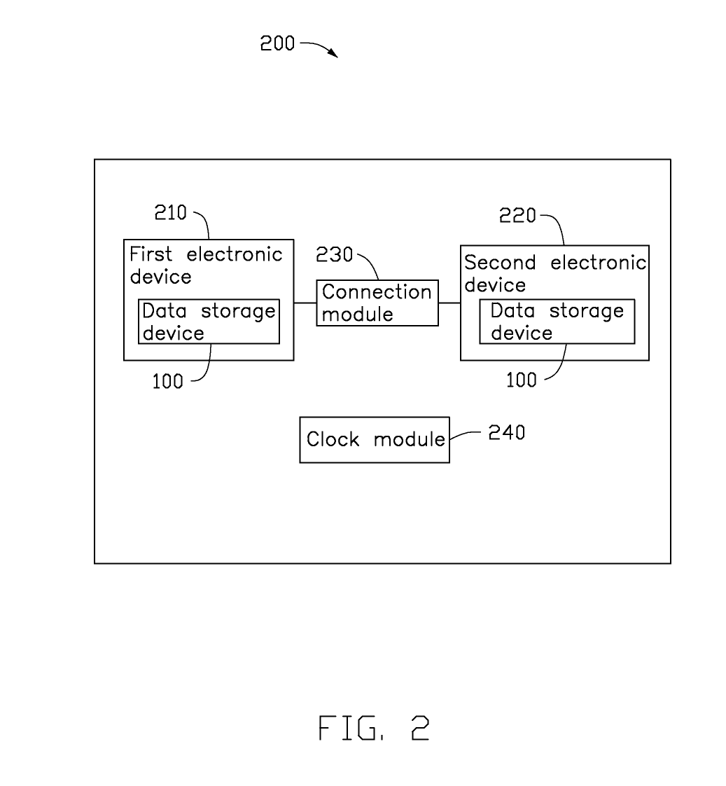

FIG. 2 illustrates an embodiment of a data transmission system 200 includes a first electronic device 210, a second electronic device 220, and a connection module 230. The data storage devices 100 are respectively received in the first electronic device 210 and the second electronic device 220 through the first PCIE interface 21. Data transmission between the first electronic device 210 and the second electronic device 220 is through the second PCIE interface 22 and the third PCIE interface 23 of the data storage device 100 of the first electronic device 210, the connection module 230, and the second PCIE interface 22 and the third PCIE interface 23 of the data storage device 100 of the second electronic device 220.

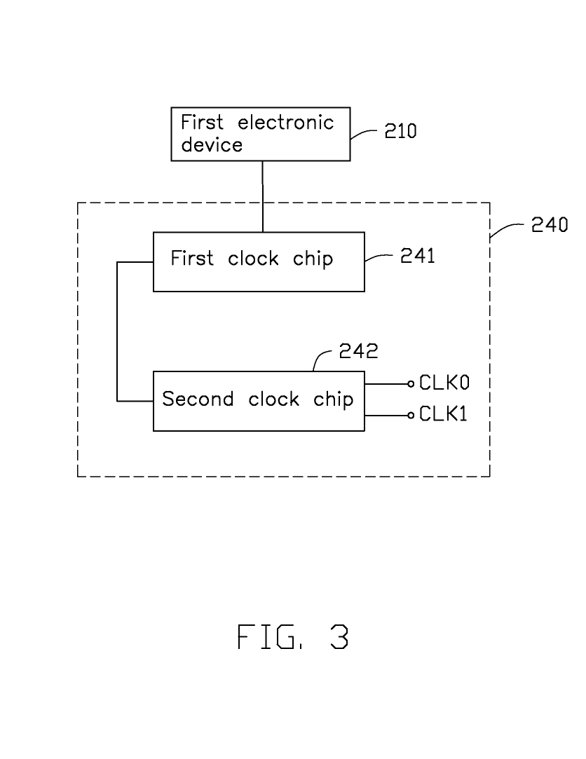

In the illustrated embodiment, the data transmission system 200 further includes a clock module 240. FIG. 3 illustrates the clock module 240 includes a first clock chip 241 and a second clock chip 242. The first clock chip 241 is coupled to the first electronic device 210. The first clock chip 241 receives a clock source and generates a clock signal. The first clock chip 241 is coupled to the second clock chip 242 and outputs the clock signal to the second clock chip 242. The second clock chip 242 generates a differential clock signal CLK0, CLK1 and outputs the differential clock signal CLK0, CLK1 to the second electronic device 220 through the connection module 230. Thus, a clock of the first electronic device 210 is synchronized with a clock of the second electronic device 220.

When the first electronic device 210 and the second electronic device 220 perform large data transmission, the second PCIE interface 22 and the third PCIE interface 23 of the data storage device 100 of the first electronic device 210 and the second PCIE interface 22 and the third PCIE interface 23 of the data storage device 100 of the second electronic device 220 perform high speed data transmission and reception. The maximum data transfer rates for traditional SATA equipment only is 600 MB/s. In contrast, the data transfer rates for PCIE equipment can be 6.4 GB/s. The data transmission system 200 takes less time to perform the large data transmission and storage.

It is believed that the discussed embodiments and their advantages will be understood from the foregoing description, and it will be apparent that various changes may be made thereto without departing from the disclosure or sacrificing all of its material advantages. The embodiments discussed herein do not limit the following claims.

What is claimed is:

1. A data storage device comprising:
a field-programmable gate array (FPGA) chip;
a plurality of high speed transmission interfaces coupled to the FPGA chip;
a plurality of first storage units coupled to the FPGA chip, wherein the FPGA chip controls the plurality of first storage units to be used as caches;
a second storage unit coupled to the FPGA chip and configured to store a start configuration for a quick start-up; and
a third storage unit coupled to the FPGA chip, wherein the FPGA chip controls the third storage unit to store data.

2. The data storage device of claim 1, wherein the plurality of high speed transmission interfaces is peripheral component interconnect express (PCIE) interfaces.

3. The data storage device of claim 1, wherein the plurality of first storage units is double data rate SDRAM3 (DDR3), and the second storage unit is a flash memory.

4. The data storage device of claim 1, further comprising a signal switch unit and a connection unit, wherein the third storage unit is coupled to the FPGA chip through the connection unit and the signal switch unit.

5. The data storage device of claim 4, wherein the signal switch unit is coupled to the FPGA chip through a PCIE bus, the third storage unit is serial advanced technology attachment (SATA) hard disk, and the connection unit is a serial attached small computer system interface (SAS) connection unit.

6. The data storage device of claim 5, wherein the third storage unit is four SATA hard disks, and the connection unit supports four SATA hard disks.

7. A data transmission system comprising:
a first electronic device comprising a data storage device;
a second electronic device comprising a data storage device; and
a connection module coupled to the first electronic device and the second electronic device, wherein the data storage device comprising:
a field-programmable gate array (FPGA) chip;
a plurality of high speed transmission interfaces coupled to the FPGA chip;
a plurality of first storage units coupled to the FPGA chip, wherein the FPGA chip controls the plurality of first storage units to be used as caches of the data storage device;
a second storage unit coupled to the FPGA chip, to store a start configuration for quick start-up of the data storage device; and
a third storage unit coupled to the FPGA chip, wherein the FPGA chip controls the third storage unit to store data.

8. The data transmission system of claim 7, wherein the plurality of high speed transmission interfaces is peripheral component interconnect express (PCIE) interfaces, and the plurality of high speed transmission interfaces is a first PCIE interface, a second PCIE interface, and a third PCIE interface.

9. The data transmission system of claim 8, wherein the data storage devices are respectively received in the first electronic device and the second electronic device through the first PCIE interface, and wherein the data transmission between the first electronic device and the second electronic device are through the second PCIE interface and the third PCIE interface of the data storage device of the first electronic device, the connection module, and the second PCIE interface and the third PCIE interface of the data storage device of the second electronic device.

10. The data transmission system of claim 9, further comprising a clock module, wherein the clock module comprises a first clock chip and a second clock chip, and wherein the first clock chip is coupled to the first electronic device and the second clock chip.

11. The data transmission system of claim 10, wherein the first clock chip receives a clock source, generates and outputs a clock signal to the second clock chip, and wherein the second clock chip generates a differential clock signal and outputs the differential clock signal to the second electronic device through the connection module.

12. The data transmission system of claim 7, wherein the plurality of first storage units is double data rate SDRAM3 (DDR3), and the second storage unit is a flash memory.

13. The data transmission system of claim 7, wherein the data storage device further comprises a signal switch unit and a connection unit, and wherein the third storage unit is coupled to the FPGA chip through the connection unit and the signal switch unit.

14. The data transmission system of claim 13, wherein the signal switch unit is coupled to the FPGA chip through a PCIE bus, the third storage unit is serial advanced technology attachment (SATA) hard disk, and the connection unit is a serial attached small computer system interface (SAS) connection unit.

15. The data transmission system of claim 14, wherein the third storage unit is four SATA hard disks, and the connection unit supports four SATA hard disks.
